(19) United States
(12) Patent Application Publication
(10) Pub. No.: US 2026/0186962 A1
(43) Pub. Date: Jul. 2, 2026

(54) ADAPTIVE ERROR RATE BASED GARBAGE COLLECTION TO INCREASE DRIVE RELIABILITY AND LIFESPAN

(71) Applicant: Microchip Technology Incorporated, Chandler, AZ (US)

(72) Inventors: Hayes Hsueh, San Jose, CA (US); Pitamber Shukla, San Jose, CA (US); Salvatrice Scommegna, Cornate D'Adda (IT)

(73) Assignee: Microchip Technology Incorporated, Chandler, AZ (US)

(21) Appl. No.: 19/224,066

(22) Filed: May 30, 2025

Related U.S. Application Data
(60) Provisional application No. 63/738,897, filed on Dec. 26, 2024.

(51) Int. Cl. G06F 12/02; G06F 3/06

(52) U.S. Cl. CPC G06F 12/0253; G06F 3/0616; G06F 3/0619; G06F 3/0658; G06F 3/0679

(57) ABSTRACT

A computer-implemented method for increasing reliability of a NAND flash device, the method comprising performing, via a flash controller, the operations of determining a read error rate of a virtual block included in the NAND flash device; determining, based at least in part on the read error rate, that garbage collection should be performed on the virtual block; and performing, based on the determination that garbage collection should be performed, the garbage collection on the virtual block.

### CROSS-REFERENCE TO RELATED APPLICATIONS

The current patent application claims the benefit under 35 U.S.C. § 119(e) of the priority date of U.S. Provisional Application Ser. No. 63/738,897 titled “ADAPTIVE ERROR RATE BASED GARBAGE COLLECTION TO INCREASE DRIVE RELIABILITY AND LIFESPAN” and filed Dec. 26, 2024. The Provisional Application is hereby incorporated by reference, in its entirety, into the current patent application.

### TECHNICAL FIELD

Various examples of the present disclosure relate to systems, media, and methods for adaptive error rate based garbage collection to increase drive reliability and lifespan.

### BACKGROUND

NOT-AND (NAND) flash devices, such as solid-state drives (SSDs), routinely perform a process known as garbage collection to maintain performance. Broadly, garbage collection seeks to prevent a drive from becoming cluttered with unused/outdated data by efficiently reorganizing the data on a block-by-block basis. A flash controller included in the NAND flash device may monitor the amount of unused/outdated information via, for instance, a set of commands (e.g., TRIM commands). However, existing garbage collection methods can lead to increased overhead, reduced write throughput, and/or late read error identification.

This background discussion is intended to provide information related to the present invention which is not necessarily prior art.

### SUMMARY OF THE INVENTION

According to various examples of the present disclosure, a computer implemented method for increasing the reliability of a NAND flash device may include performing the following operations via a flash controller: determining a read error rate of a virtual block included in the NAND flash device; determining, based at least in part on the read error rate, that garbage collection should be performed on the virtual block; and performing, based on the determination that garbage collection should be performed, the garbage collection on the virtual block. The read error rate used in determining that the garbage collection should be performed may be at least partially based on one or both of a patrol read of the virtual block or a host read of the virtual block.

According to various examples of the present disclosure, a NAND flash device is provided that includes non-transitory computer-readable media having instructions embodied/stored thereon. The instructions, when executed by at least one processor may cause the processor(s) to: determine a read error rate of a virtual block included in the NAND flash device; determine, based at least in part on the read error rate, that garbage collection should be performed on the virtual block; and perform, based on the determination that garbage collection should be performed, garbage collection on the virtual block. The read error rate may be at least partially based on one or both of a patrol read of the virtual block or a host read of the virtual block.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example system for adaptive read error rate based garbage collection;

FIG. 2 illustrates an example computing system configured to perform operations in accordance with the various examples of the present disclosure;

FIG. 3 illustrates an example non-volatile memory (NVM) media of the system of FIG. 1;

FIG. 4 illustrates an example block of FIG. 3;

FIG. 5 illustrates an example multi-plane block of an NVM of the system of FIG. 1;

FIG. 6 illustrates an example multi-plane wordline (WL) of the multi-plane block of FIG. 5; and

FIG. 7 illustrates an example method flow for adaptive read error rate based garbage collection in accordance with the system of FIG. 1.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower, horizontal, vertical, and the like) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

Broadly, the term “signal” or “electronic signal” may be used to describe an electromagnetic wave conducted through an electrically conductive medium in which an electric voltage and/or an electric current varies, or may be constant, over time.

Broadly, “error rate” of a NAND flash device (e.g., an SSD) refers to the frequency at which errors occur when writing or reading data to/from the device or a portion thereof. Error rate, which is widely considered as a key indicator of device reliability, may be measured in terms of number of errors per bit of data transferred to/from the NAND flash device. A lower error rate typically signifies better performance/reliability of the NAND flash device.

“Garbage collection” or “GC” is a process utilized by SSDs to optimize space on the drive that may also improve write performance. Generally speaking, GC involves (i) moving used data to new locations (e.g., to a block(s)) within an SSD), and (ii) erasing unused data from the SSD.

“Reliability” of a NAND flash device broadly refers to the ability of the device to consistently store/retrieve (e.g., program/read, respectively) data over time, without errors. Reliability of a NAND flash device can naturally degrade over time and through use, for example because repeated program/read cycles performed on/by the device lead to such degradation in the blocks and cells of the device.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

In various examples of the present disclosure, a data storage system may include a memory device and a controller. The memory device may store data. The data storage system may be connected to a host system. In various examples, the data storage system may be connected to the host system by wired or wireless means. In various examples, the data storage system may be connected to more than one host system, such as in a multi-tenant environment, without limitation. The controller may be operable to manage storage and retrieval of data to and from the memory device. The host system may send data to the data storage system for storage in the memory device. The controller may process the data and issue commands to the memory device for storing the data in the memory device. The host system may send a read request to the data storage system. The read request may indicate data to be retrieved from the memory device and sent back to the host system. The controller may process the read request, retrieve the data from the memory device, process the retrieved data, and send the retrieved data to the host system. In various examples, the memory device may be a NAND flash device, such as a solid-state drive (SSD), including a plurality of non-volatile memory (NVM) media (e.g., NAND-based memory media) for data storage. The NVM media may include one or more local controllers. The NVM media may be organized into a plurality of blocks. A block of NVM media is the smallest unit of data that can be erased entirely. A block of NVM media includes an arrangement of a plurality of wordlines (WLs) and a plurality of bit lines (BLs). At the intersection of each WL and BL is a transistor (or “cell”). Floating-gate transistors and/or charge traps are non-limiting examples of cells of NVM media. Additional details on the composition and/or functionality of the above-referenced NAND flash device(s) that are relevant to the present disclosure are provided in the discussion of the figures (FIGs). below.

While there are techniques, such as error correction and wear leveling, that seek to maintain the integrity of data stored on NAND flash devices, these techniques, when considered individually or in combination, are oftentimes insufficient. The present disclosure seeks to facilitate the performance of an adaptive, error rate based garbage collection by NAND flash devices to increase the reliability of said NAND flash devices.

In various examples, reliability of a NAND flash device, such as an SSD, may be maintained by, for example, determining a read error rate of a virtual block included in the NAND flash device. Based at least in part on the read error rate, it may be determined (e.g., by a controller included in the NAND flash device) that GC should be performed on the virtual block. A determination to perform GC may also or alternatively be based on a valid page count (or “VCC”) of the NAND flash device. In response to determining that GC should be performed, the GC may be performed on the virtual block. Conversely, based at least in part on the read error rate, it may be determined that GC should not be performed on the virtual block and, consequently, GC for the virtual block may be deferred, delayed, avoided or the like, at least for a period of time or responsive to a system event.

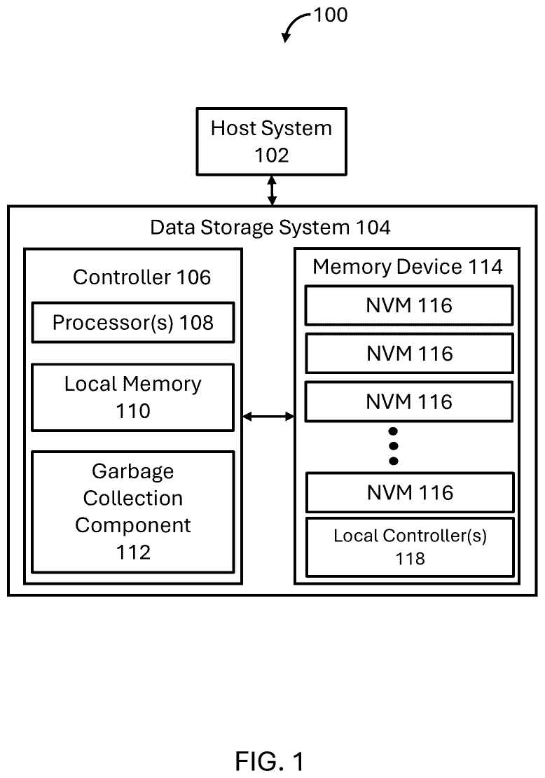

FIG. 1 illustrates an example system 100 including a host system 102 and a data storage system 104. The data storage system 104 may include a controller 106. The controller 106 may include a processor 108, a local memory 110, and garbage collection component 112. The data storage system 104 may also include a memory device 114. The memory device 114 may be or otherwise include a NAND flash device, such as an SSD. The memory device 114 may include a plurality of NVM media 116 and one or more local controller(s) 118.

In various examples, a read or write request may be received from the host system 102 via a peripheral component interconnect express (PCIe) interface that connects the data storage system 104 to servers or CPUs. PCIe is a standardized interface for motherboard components. The controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random access memory (SDRAM), without limitation.

When a data request is received from the host system 102, the controller 106 references the L2P mapping table to determine the PBA within the NVM media 116 corresponding to a desired LBA. Once the PBA is determined, the controller 106 accesses the appropriate NVM media 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the memory device 114 may support a direct memory access (DMA) operation enabling data to be written from the host system 102 directly to the NVM media 116 and read from the NVM media 116 directly to the host system 102. Certain commands may be issued to the controller 106 or the local controller(s) 118 using the host command layer, or non-volatile memory express management interface (NVMe-MI).

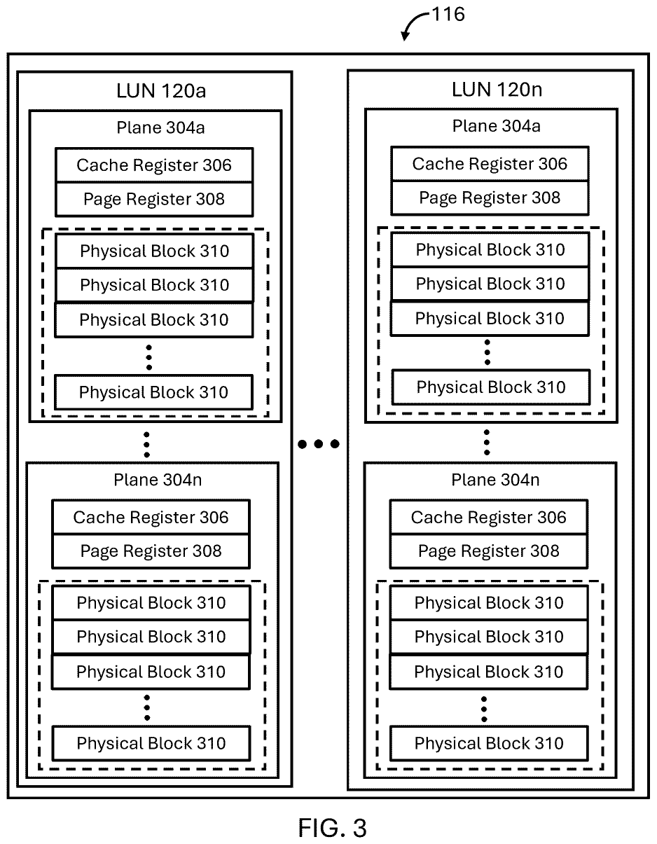

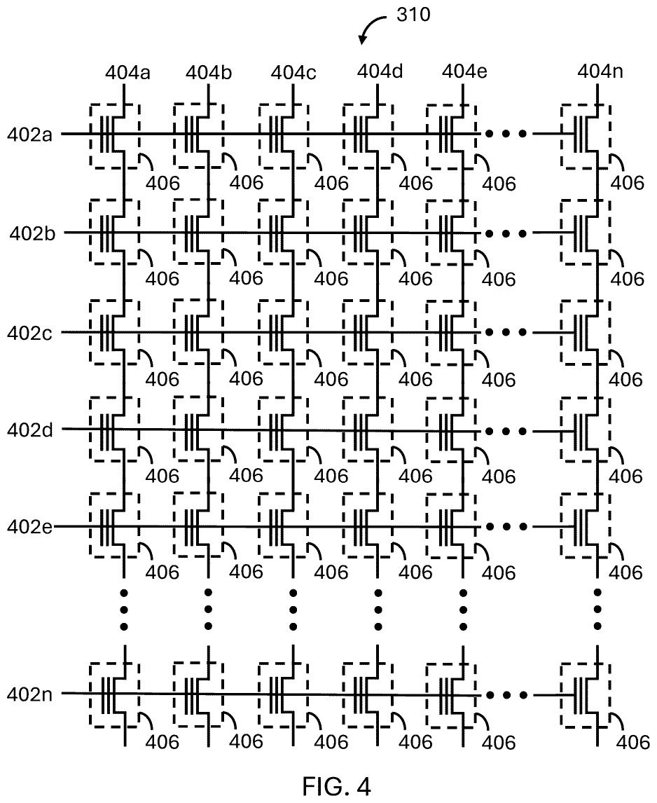

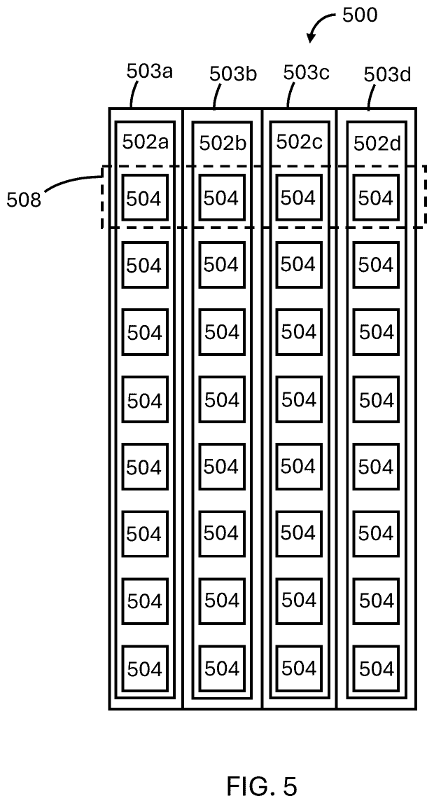

Each of the NVM media 116 may include a plurality of LUNs (e.g., the LUNs 306 of FIG. 3). Each LUN may include a plurality of planes (e.g., the planes 404-1, 4042, 4043, 404-4 of FIG. 4). Each plane may include a plurality of physical blocks (e.g., the physical blocks 410-1, 410-2, 410-3, 410-4 of FIG. 4). Each block may include a set of pages (e.g., the pages 504 of FIG. 5). Each physical block may include a set of WLs corresponding to the pages. Respective ones of the physical blocks may be organized into a multi-plane block (e.g., the multi-plane block 500 of FIG. 5). Each multi-plane block may include one (1) physical block from each plane of one (1) LUN. Each multi-plane block may include a set of multi-plane WLs (e.g., the multi-plane WL 508 of FIG. 5). Each multi-plane WL may include corresponding WLs of the physical blocks included in a multi-plane block such that each multi-plane WL includes one (1) WL from each plane of the multi-plane block. User data may be written to the pages of a multi-plane WL.

The garbage collection component 112 may increase the reliability of a NAND flash device (e.g., the memory device 114 of FIG. 1) by performing, via a flash controller, adaptive, error rate based garbage collection operations. In various examples, performing adaptive, error rate based garbage collection may include determining a read error rate of a virtual block included in the NAND flash device. The read error rate may be at least partially based on one or more of a patrol read of the virtual block, or a host read of the virtual block. Broadly, a “patrol read” is a background process executing on a NAND flash device (e.g., via the flash controller 106), such as an SSD, that periodically scans the entire device to proactively identify (and possibly fix) potential errors and/or bad sectors (e.g., blocks) affecting/within the device. A “host read” typically refers to a read operation that is initiated by the (host) computer system (e.g., Host System 102). Host reads may be initiated to access data stored on a NAND flash device during ordinary use of the device (e.g., while opening files, loading applications, and/or transferring data).

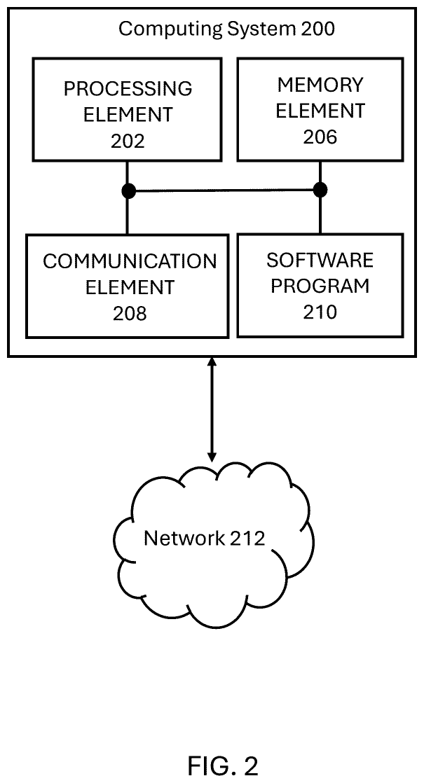

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1), a data storage system (e.g., the data storage system 104 of FIG. 1), and/or another computing device in accordance with the examples of the present disclosure, without limitation.

The software program 210 may be configured with instructions for performing and/or enabling performance of at least some of the steps set forth herein. In an embodiment, the software program 210 comprises instructions stored on computer-readable media of memory element 206. In various examples, the software program 210 may include instructions for performing operations of the garbage collection component 112 discussed with reference to FIG. 1.

The communication network 212 generally allows communication between the computing system 200 and another computing device, such as between a remote host system (e.g., the host system 102), a local host system, and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain embodiments, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some embodiments, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In an embodiment, the memory element 206 respectively store the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the memory device 114 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

Turning to FIG. 3, the NVM media 116 may respectively include one or more chip enable (CE) ports and a plurality of dies. In various examples, the NVM media 116 may respectively include two (2), four (4), eight (8), sixteen (16), twenty four (24), thirty two (32), or more dies, without limitation. Each die may correspond to a logical unit (LUN). Each NVM 116 may include LUNs 120a, . . . 120n. Each LUN 120a, . . . 120n may include a plurality of planes 304a, . . . 304n. Each LUN 120a, . . . 120n may include, for example, four (4), six (6), eight (8), or more planes, without limitation.

Each plane may include a cache register 306, a page register 308, and a plurality of physical memory blocks 310. In various examples, the controller 106 may write incoming data to more than one NVM media 116 in parallel. The NVM media 116 may write incoming data to more than one LUN in parallel.

When data is written to or retrieved from the NVM media 116, the data may be temporarily stored in one of the cache register 306 and the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

In various examples, the physical blocks 310 may be organized into virtual blocks (VBs). A VB may include one physical block of each NVM 116 of the memory device 114. Each VB may include a set of virtual wordlines (VWLs). Each VWL may include a set of WLs (e.g., a VWL may include one (1) WL from each physical block of a VB). Additional description of WLs described in connection with FIG. 4 below. In various examples, the data processing and programming operations of this disclosure may be performed on a VB/VWL basis. Also or alternatively, the data processing and programming operations may be performed on a physical block/WL basis without departing from the spirit of the present disclosure.

Turning to FIG. 4, each of the physical memory blocks 310 includes a plurality of wordlines (WLs) 402a, 402b, 402c, 402d, 402e, . . . 402n, a plurality of bit lines (BLs) 404a, 404b, 404c, 404d, 404e, . . . 404n, and a plurality of cells 406. In various examples, a page may be defined as a row of cells connected to the same WL (e.g., the cells 406 connected to the WL 402a are collectively referred to as a page). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block basis.

Generally, each WL is an electronic signal that, according to its voltage level, selects a row (or page) of cells. (Each WL 402a, 402b, 402c, 402d, 402e, . . . 402n may be drawn as a horizontal line shown in FIG. 4.) Each WL may be connected to control gates of the cells in a respective row of cells. When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electronic signal that connects the drains of cells in a column of cells. (Each BL 404a, 404b, 404c, 404d, 404e, . . . 404n may be drawn as a vertical line shown in FIG. 4.) Each BL, according to its voltage level, may enable data transfer to and from the cells of a selected WL during read and write operations. During a read operation, the voltage on the BL reflects a state of the selected cells (or page). Accordingly, the voltage of the BL may be measured to determine the value of the data in the selected cells. In other words, WLs effectively address rows of cells where data is being programmed to or read from, while BLs are highways on which data travel to reach the desired cell(s).

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402a, 402b, 402c, 402d, 402e, . . . 402n may be SLC wordlines, MLC wordlines, QLC wordlines and/or PLC wordlines, without limitation. In an example, a TLC wordline may include a lower page, a middle page, and an upper page. The lower page, middle page, and upper page may correspond to a page including a string of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

Generally, a read voltage threshold may correspond to a reference voltage used when reading data from a cell. During a read operation, a read voltage may be applied to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

FIG. 5 illustrates a multi-plane block 500 of an NVM (e.g., the NVM 116 of FIG. 1). The multi-plane block may include physical blocks 502a, 502b, 502c, 502d, wherein the physical blocks 502a-502d may correspond to the physical blocks 310 of FIG. 3. The physical blocks 502a, 502b, 502c, 502d may be included in a set of planes 503a, 503b, 503c, 503d. Each physical block 502a, 502b, 502c, 502d may include a set of pages 504, wherein each individual page included in the set of pages 504 may correspond to the page described in the discussion of FIG. 4 above (e.g., the cells 406 connected to the WL 402a comprise one page). A multi-plane WL 508 may be formed to include a page 504 of each physical block 502a, 502b, 502c, 502d.

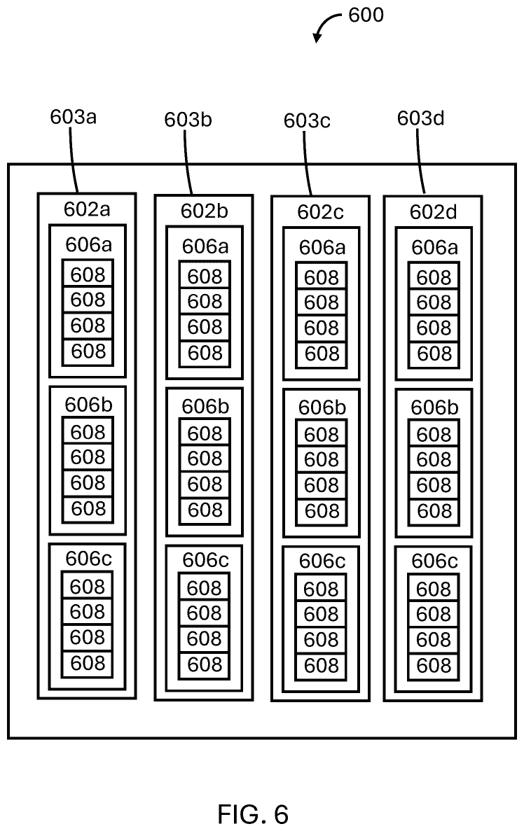

FIG. 6 illustrates a multi-plane WL 600 of a multi-plane block (e.g., the multi-plane block 500 of FIG. 5). The multi-plane WL 600 may include pages 602a, 602b, 602c, 602d. The pages 602a, 602b, 602c, 602d may be included in a set of physical blocks 603a, 603b, 603c, 603d that make up the multi-plane block. The pages 602a, 602b, 602c, 602d may be TLC pages that include TLC cells. Accordingly, each of the pages 602a, 602b, 602c, 602d may include an upper page 606a, a middle page 606b, and a lower page 606c. It would be appreciated by one of ordinary skill in the art that the pages 602a, 602b, 602c, 602d could include SLC pages, MLC pages, TLC, QLC pages, and/or PLC pages without departing from the spirit of the present disclosure. A plurality of data frames 608 may be stored in each of the upper pages 606a, middle pages 606b, and lower pages 606c.

The present disclosure seeks to utilize error information collected during/resulting from patrol and/or host reads, both of which occur repeatedly during ordinary operation of a NAND flash device/SSD that is being actively used, to determine whether garbage collection should be performed on a virtual block(s) of the NAND flash device/SSD. The patrol/host read error rate may be used alone or in combination with other/additional criteria. For example, the criteria may include one or both of an error profile of a virtual block(s) included in the NAND flash device, or a VCC of the virtual block(s).

In the examples in which a VCC is used in combination with the (patrol and/or host) read error rate and/or the error profile, the flash controller included in/communicatively coupled to the NAND flash device may also determine a VCC of the virtual block(s) which are the subject of the GC determination.

The error profile may be at least partially based on one or more of an error index of the virtual block(s), or an error code affecting the NAND flash device. The “error index” of the virtual block(s) may be a representation of the number of errors or failed read/write operations experienced by the virtual block(s), and may be in the form of an error histogram. The error histogram may further include information corresponding to an error code affecting the NAND flash device. The error code affecting the NAND flash device may be a low-density parity check (or “LDPC”).

In accordance with various examples of the present disclosure, the criteria on which the determination to perform the GC is based may be represented as a mathematical expression. The mathematical expression may be an equation. The equation may have a solution that is directly proportional to a sum of two terms. The first term may include a weight (w) times a difference between an average VCC (VCC_{avg}) and a current VCC (VCC_{cur}), and the second term may include an error index (EI) multiplied by a second weight. The second weight may be a quantity of 1 minus the weight (i.e., the first weight associated with the first term). In various examples, each of the weights may be variable between zero (0) and one (1) and/or may be codependent. Mathematially, an expression on which the garbage collection component 112 bases the decision to perform GC, referred to herein as the “GC determination function,” may be represented as:

$$f ( VCC , EI ) = [ w * ( {VCC}_{avg} - {VCC}_{cur} ) ] + [ ( 1 - w ) * EI ]$$

As mentioned above, the error index (EI) is a representation of the number of errors, or failed read and/or write operations, experienced by the virtual block(s) under consideration, which may be depicted as an error histogram. Each virtual block of the NAND flash device may have its own error histogram. The error histogram of a particular block of NAND flash may have or be rendered to include a y-axis and an x-axis. The y-axis of the error histogram may correspond to the number of 4k read operations performed on the virtual block (e.g., over a given period of time, including up to the lifespan of the NAND flash device), and the x-axis of the error histogram may correspond to a number of number of bit errors experienced/incurred by the block (e.g., over the given period of time). Frequently, an error histogram will be used to represent or illustrate the number of bit errors experienced/incurred by a virtual block during a number of read operations that occurred most recently (e.g., over the past one (1) second(s)).

Accordingly, the error histogram of a particular virtual block (e.g., VB0) of a NAND flash device may keep track of a number of correctable error bits per read operation performed on a 4k sector of VB0. The number of read operations performed on VB0 may be a total number of read operations performed over a period of time (e.g., over the past microsecond, the past second, the past minute, the past hour, the past day, etc., up to and including the lifespan of the NAND flash device). The read operations may correspond to host reads, patrol reads, or a combination thereof. Since host reads may be targeted to specific block(s) of the NAND flash device while patrol reads may indiscriminately scan all blocks of the NAND flash device, it is possible that a patrol read would capture critical information that would have otherwise been missed by a host read.

The VCC_{avg} may be the average VCC of a group of virtual blocks included in the NAND flash device (e.g., the average VCC of ten (10) virtual blocks included in the NAND flash device).

The VCC_{cur} may be the VCC of a particular virtual block (e.g., the virtual block that is under consideration and is the target of a read operation that is being/about to be performed).

Each respective weight may be, or be at least partially based on: a static value (e.g., four (4)), an output of one or more functions (e.g., a “weight determination function(s)”) based on one or more variables that can be monitored by the flash controller, and/or combinations thereof. The value for each respective weight may also or alternatively be determined by referencing, or may otherwise be retrieved from, a lookup table (LUT).

In various examples, a static value upon which a weight is at least partially based may be, or at least partially include, the output of the one or more weight determination functions. In various examples, the weight determination function(s) for determining the first weight may be of a higher or lower order than the weight determination function(s) for determining the second weight, and vice-versa. The weight determination function(s) for determining each respective weight may also or alternatively be of a higher or lower order than the GC determination function. Additionally and/or alternatively, the one or more weight determination function(s) used to determine each of the first and second weights and/or the GC determination function may be non-linear.

A LUT referenced when determining the weight(s) may include one or more of: a static value (e.g., the static value described above and/or other static values provided by the manufacturer of the NAND flash), one or more mathematical functions/expressions based on one or more variables that can be monitored by the flash controller (e.g., the weight determination function(s) referenced above, which in some examples, may be provided by the manufacturer of the NAND flash), or a combination thereof. The LUT may be provided on the NAND flash device, e.g., by the NAND manufacturer, on, for instance, local memory (e.g., the Local Memory 110 of FIG. 1) included therein.

According to various examples of the present disclosure, the one or more variables that can be monitored by the flash controller may include, but are not limited to: an elapsed time, a temperature of the NAND flash device at a point in time, a temperature of the NAND flash device over a period of time, a temperature of a virtual block of the NAND flash device at a point in time, a temperature of a virtual block of the NAND flash device over a period of time, a total number of program-erase (or “P/E”) cycles performed over the lifetime of the NAND flash device, a number of P/E cycles performed on the NAND flash device over a period of time, a total number of P/E cycles performed on a virtual block of the NAND flash device over the lifetime of the NAND flash device, or a total number of P/E cycles performed on a virtual block of the NAND flash device over a period of time. These variables may be monitored by, e.g., software executed by the flash controller, software executing elsewhere on the NAND flash device, sensors included in or communicatively coupled to the NAND flash device, and/or a combination thereof.

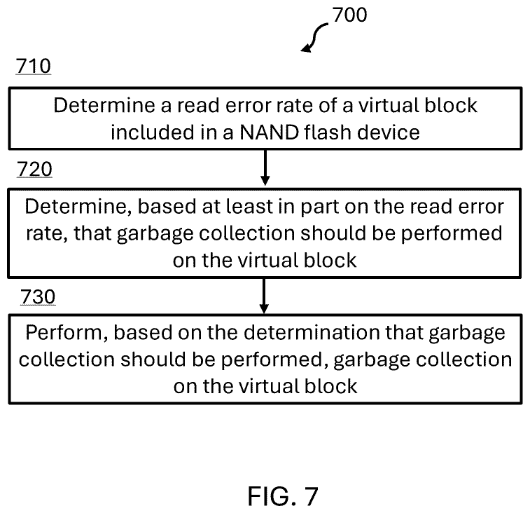

FIG. 7 illustrates a computer-implemented method 700 for adaptive error rate based garbage collection. The steps may be performed in the order shown in FIG. 7, or the steps may be performed in a different order. Furthermore, some steps may be performed concurrently as opposed to sequentially. In addition, some steps may be optional.

The method 700 may be performed by a controller (e.g., the controller 106 and/or controller(s) 118 of FIG. 1) of a data storage system (e.g., the data storage system 104 of FIG. 1). The method 700 may operate on a block of an NVM described in more detail above in connection with FIGS. 1-6. However, a person having ordinary skill will appreciate that responsibility for all or some of the operations described herein may be distributed differently among such devices or other computing devices without departing from the spirit of the present disclosure.

The controller may manage storage and retrieval of data to and from a memory device (e.g., the memory device 114 of FIG. 1). The controller may receive read and write requests from a host system (e.g., the host system 102 of FIG. 1). Upon receiving a write request, the controller may facilitate writing data received from the host system to the memory device. Upon receiving a read request, the controller may facilitate reading of data from the memory device and communication of the data to the host system, as discussed in more detail below.

One or more computer-readable medium(s) may also be provided. The computer-readable medium(s) may include one or more executable programs stored thereon, such as firmware programs, wherein the program(s) instruct one or more processing elements to perform all or certain of the steps or operations outlined herein. The program(s) stored on the computer-readable medium(s) may instruct the processing element(s) to perform additional, fewer, or alternative actions, including those discussed elsewhere herein.

At operation 710, a read error rate of a virtual block included in a NAND flash device (e.g., the memory device 114 of FIG. 1) may be determined. The read error rate may be at least partially based on a patrol read of the virtual block, a host read of the virtual block, or a combination thereof. Components of/circuitry included in the memory device 114, or communicatively coupled thereto (such as the garbage collection component 112 of FIG. 1) may be at least partially responsible for determining the read error rate. Once determined, the read error rate may be represented as an error histogram, e.g., as described above.

At operation 720, a determination, based at least in part on the read error rate, is made that GC should be performed on the virtual block. The garbage collection component 112 may be at least partially responsible for determining that the GC should be performed on the virtual block. When determining to perform GC on the virtual block, the garbage collection component 112 may also and/or alternatively at least partially consider an error profile, a VCC of the virtual block, and/or a set of criteria. The criteria may include/be at least partially based on one or more of an error index of the virtual block or an error code affecting the NAND flash device. In various examples of the present disclosure, the error index may be an error histogram and the error code may be a LDPC.

The criteria may be represented as a mathematical expression, or an equation. The solution to the equation may be directly proportional to the sum of two terms—the first term corresponding to a weight times a difference between an average VCC and a current VCC, the second term corresponding to an error index multiplied by a second weight (e.g., quantity of 1 minus the (first) weight).

The error profile of the virtual block, the VCC of the virtual block, and the criteria including the error index and error code may be represented as a mathematical expression, such as an equation and/or graphically (e.g., as an error histogram). Additional details on each of the error profile, VCC, criteria, equation, and error histogram are provided above.

At operation 730, the GC is performed on the virtual block based on the determination that GC should be performed made at operation 720.

Through hardware, software, firmware, or various combinations thereof, any of the processing elements (e.g., the controller 106 and/or local controller(s) of FIG. 1, the processing element 202 of FIG. 2, and/or the controller 302 of FIG. 3) may—alone or in combination with other processing elements—be configured to perform the operations of embodiments of the present disclosure. The embodiments described herein in connection with the attached drawing figures are intended to describe aspects of the disclosure in sufficient detail to enable those skilled in the art to practice the disclosure. Other embodiments can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

For example, a determination may be made as described in more detail above, except that the determination may be not to perform GC on the virtual block under consideration. More particularly, based at least in part on the read error rate, it may be determined that GC should not be performed on the virtual block and, consequently, GC for the virtual block may be deferred, delayed, avoided or the like, at least for a period of time or responsive to a system event.

### Feature Combinations

According to various examples of the present disclosure, computer-implemented methods for increasing the reliability of a NAND flash device, such as an SSD, may include performing the following operations via a flash controller: determining a read error rate of a virtual block included in the NAND flash device; determining, based at least in part on the read-error rate, that garbage collection should be performed on the virtual block; and performing, based on the determination that garbage collection should be performed, the garbage collection on the virtual block.

In combination with any of the previous examples, a read error rate used in determining that garbage collection should be performed may be at least partially based on one or more of: (i) a patrol read of a virtual block, or (ii) a host read of a virtual block.

In combination with any of the previous examples, a flash controller (e.g., included in a NAND flash device) my perform operations for determining a valid page count (or “VCC”) of a virtual block, and a determination that garbage collection should be performed may be based on the VCC.

In combination with any of the previous examples, a determination that garbage collection should be performed may be at least partially based on criteria including one or more of: (i) an error profile of a virtual block, or (ii) a VCC of a virtual block.

In combination with any of the previous examples, criteria (e.g., for determining that garbage collection should be performed) may be at least partially based on one or both of: (i) an error index of a virtual block, or (ii) an error code affecting a NAND flash device.

In combination with any of the previous examples, an error index may be an error histogram and an error code may be a low-density parity check.

In combination with any of the previous examples, determining that garbage collection should be performed may be based on criteria which may be represented as a mathematical expression.

In combination with any of the previous examples, a mathematical expression may be an equation, a solution of the equation may be directly proportional to a sum of a first term and a second term, the first term may comprise a weight times the difference between an average VCC and a current VCC, and the second term may comprise an error index multiplied by a quantity 1 minus the weight.

In combination with any of the previous examples, a weight may be variable between zero (0) and one (1).

In combination with any of the previous examples, a weight may be one or more of: a static value, an output of one or more functions based on one or more variables that can be monitored by a flash controller, or determined by reference to a lookup table.

In combination with any of the previous examples, one or more variables that may be monitored by a flash controller include: an elapsed time, a temperature of the NAND flash device at a point in time, a temperature of the NAND flash device over a period of time, a temperature of a virtual block of the NAND flash device at a point in time, a temperature of a virtual block of the NAND flash device over a period of time, a total number of P/E cycles performed over the lifetime of the NAND flash device, a number of P/E cycles performed on the NAND flash device over a period of time, a total number of P/E cycles performed on a virtual block of the NAND flash device over the lifetime of the NAND flash device, or a total number of P/E cycles performed on a virtual block of the NAND flash device over a period of time.

According to various examples of the present disclosure, non-transitory computer-readable media having instructions stored thereon are provided which, when executed by one or more processors, cause the one or more processors to perform the steps comprising the computer-implemented method described above.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A computer-implemented method for increasing the reliability of a NAND flash device, the method comprising performing the following operations via a flash controller:
determining a read error rate of a virtual block included in the NAND flash device;
determining, based at least in part on the read error rate, that garbage collection (GC) should be performed on the virtual block; and
performing, based on the determination that GC should be performed, the GC on the virtual block.

2. The computer-implemented method of claim 1, wherein the read error rate used in determining that the GC should be performed is at least partially based on one or both of: (i) a patrol read of the virtual block, or (ii) a host read of the virtual block.

3. The computer-implemented method of claim 1, comprising performing the following operations via the flash controller:
determining a valid page count (VCC) of the virtual block, the determination that GC should be performed being based on the VCC.

4. The computer-implemented method of claim 3, wherein the determining that the GC should be performed is based on criteria including one or more of: (i) an error profile of the virtual block, or (ii) the VCC of the virtual block.

5. The computer-implemented method of claim 4, wherein the criteria include the error profile and the error profile is based on one or both of: (i) an error index of the virtual block, or (ii) an error code affecting the NAND flash device.

6. The computer-implemented method of claim 5, wherein the error index is an error histogram and the error code is a low-density parity check.

7. The computer-implemented method of claim 1, wherein the determining that the GC should be performed is based on criteria which can be represented as a mathematical expression.

8. The computer-implemented method of claim 7, wherein:
the mathematical expression is expressible in an equation,
a solution of the equation is directly proportional to a sum of a first term and a second term,
the first term comprises a weight times the difference between an average VCC and a current VCC,
the second term comprises an error index multiplied by a quantity of 1 minus the weight.

9. The computer-implemented method of claim 8, wherein the weight is variable between zero (0) and one (1).

10. The computer-implemented method of claim 9, wherein the weight is on one or more of:
a static value,
an output of one or more functions based on one or more variables that can be monitored by the flash controller, or
determined by reference to a lookup table.

11. The computer-implemented method of claim 10, wherein:
the one or more variables that can be monitored by the flash controller include: an elapsed time, a temperature of the NAND flash device at a point in time, a temperature of the NAND flash device over a period of time, a temperature of a virtual block of the NAND flash device at a point in time, a temperature of a virtual block of the NAND flash device over a period of time, a total number of P/E cycles performed over the lifetime of the NAND flash device, a number of P/E cycles performed on the NAND flash device over a period of time, a total number of P/E cycles performed on a virtual block of the NAND flash device over the lifetime of the NAND flash device, or a total number of P/E cycles performed on a virtual block of the NAND flash device over a period of time.

12. Non-transitory computer-readable media of a NAND flash device controller, the non-transitory computer-readable media having instructions embodied thereon which, when executed by one or more processors, cause the one or more processors to:
determine a read error rate of a virtual block included in the NAND flash device;
determine, based at least in part on the read error rate, that GC should be performed on the virtual block; and
perform, based on the determination that GC be performed, the GC on the virtual block.

13. The non-transitory computer-readable media of claim 12, wherein the determining that the GC should be performed is based on criteria including one or more of: (i) an error profile of the virtual block, or (ii) a VCC of the virtual block.

14. The non-transitory computer-readable media of claim 13, wherein:
the read error rate is at least partially based one or both of: (i) a patrol read of the virtual block, or (ii) a host read of the virtual block.

15. The non-transitory computer-readable media of claim 13, wherein:
the error profile is based on one or both of: (i) an error index of the virtual block, or (ii) an error code affecting the NAND flash device,

16. The non-transitory computer-readable media of claim 15, wherein the error index is an error histogram and the error code is a low-density parity check.

17. The non-transitory computer-readable media of claim 12, wherein—
the determining that the GC should be performed is based on criteria that is expressible as a mathematical equation,
a solution of the equation is directly proportional to a sum of a first term and a second term,
the first term comprises a weight times the difference between an average VCC and a current VCC,
the second term comprises an error index multiplied by a quantity of 1 minus the weight.

18. The non-transitory computer-readable media of claim 17, wherein the weight is variable between zero (0) and one (1).

19. The non-transitory computer-readable media of claim 18, wherein the weight is one or more of:
a static value,
an output of one or more functions based on one or more variables that can be monitored by the flash controller, or
determined by reference to a lookup table.

20. The non-transitory computer-readable media of claim 19, wherein:
the one or more variables that can be monitored by the flash controller include: an elapsed time, a temperature of the NAND flash device at a point in time, a temperature of the NAND flash device over a period of time, a temperature of a virtual block of the NAND flash device at a point in time, a temperature of a virtual block of the NAND flash device over a period of time, a total number of P/E cycles performed over the lifetime of the NAND flash device, a number of P/E cycles performed on the NAND flash device over a period of time, a total number of P/E cycles performed on a virtual block of the NAND flash device over the lifetime of the NAND flash device, or a total number of P/E cycles performed on a virtual block of the NAND flash device over a period of time.
